(19) United States
(12) Patent Application Publication
(10) Pub. No.: US 2007/0206629 A1
(43) Pub. Date: Sep. 6, 2007

(54) Network Equipment Applied In Power Line Carrier Communication System

(75) Inventor: Richard Choi, Taipei (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Lite-On Technology Corp., Taipei (TW)

(21) Appl. No.: 11/670,951

(22) Filed: Feb. 2, 2007

(30) Foreign Application Priority Data
Mar. 3, 2006 (TW) 095107337

(51) Int. Cl. H04L 12/66

(52) U.S. Cl. 370/463

(57) ABSTRACT

A network equipment for a communication between a network and a computer is provided. The network equipment includes a network adapter for transmitting a network signal from Internet via a conducting line and a wireless transmitting device for wirelessly transmitting the network signal to a plurality of computers via the conducting line, wherein the network adapter includes an adapter body, a receptacle portion disposed on the adapter body, and a plug to be inserted into a socket to transfer the network signal to the conducting line. The wireless transmitting device includes a device body and a lamp base connector connected with the device body, detachably and electrically connected with a bulb socket and wirelessly transmitting the network signal to the plurality of computers via the conducting line.

### FIELD OF THE INVENTION

The present invention relates to a network equipment, and more particularly to a network equipment applied in a power line carrier communication system which has a wireless transmitting structure and provides a more efficient communication quality.

### BACKGROUND OF THE INVENTION

The signals in network used to be transmitted by way of either the network cable or the telephone line. However, recently there comes a new method of carrying sound and data signals such as Internet, telephone, and images via the existing fundamental power line, i.e. a power line carrier communication system.

The power line carrier communication technique is performed by converting the data signal into the high-frequency signal and transmitting it to the general users via the existing power wire net disposed for carrying power. For the outdoor installation of the system, a device is disposed on the transformer to integrate the sounds and data with low-voltage and current and deliver them far away. For the indoor installation of the system, a network adapter is used to sift the data, sounds, and power separately for different applications, e.g. the power for a computer, Internet, and telephone.

The power line carrier communication technique is a kind of interface-sharing technique, and thus plural terminating machines (e.g. PC, telephone) can be connected with each other and share the bandwidth via the same power distribution contact, where the bandwidth is under an optimal management to provide adequate bandwidth for every user. The transmission bandwidth in the power line carrier communication system announced by the HomePlug Powerline Alliance (HPA) is 14 Mbps in theory and 7˜8 Mbps in practice.

The power line carrier communication system can cooperate with the existing wired and wireless network environments and need not create a whole new independent network system. The current wireless network system only has about 150 ft indoor effective range, and is usually interfered by radiophones and some microwaves. Therefore, the power line carrier communication system can make up for the mentioned deficiency.

FIG. 1 is a schematic diagram showing the framework of a power line carrier communication system cooperating with a wireless network system in the prior art. A modem 11 receives signals from the Internet 10, and a network adapter 12 is connected with the modem 11 by a network cable 11. The network adapter 12 transmits the network signals from the Internet 10 to a first socket 13 via a first plug 121, and then the network signals are transmitted to an second socket 14 via a power line 131, and thus a wireless transmitting device 15 can receive the network signals from the second socket 14 via a second plug 151 and transmit them to a plurality of computers 16 via a wireless transmission 152.

Please refer to FIGS. 2(A) and 2(B), wherein FIG. 2(A) is a schematic diagram showing the structure of a conventional network adapter device, and FIG. 2(B) is a schematic diagram showing the structure of a conventional wireless network transmission device. The structure of the network adapter 12 is similar to an ordinary transformer and has a body 122, two terminals 123 and a network port 124, wherein the terminals 123 are plugged into the first socket 13 of FIG. 1 and the network cable 111 of FIG. 1 is plugged into the network port 124. The wireless transmitting device 15 has a body 153, a plug 151, a power line 154 and an antenna 155, wherein the structure of the plug 151 is similar to the network adapter 12 and the plug 151 is plugged into the second socket 14 of FIG. 1.

The conventional network adapters do not have any unbearable problems in use for the time being, but they are usually too big in volume to be received. Besides, the conventional wireless transmitting devices must be used with the power sockets since they need power for operation.

However, everyone knows that the effective wireless transmission scope is greatly influenced by the placement of the wireless transmitting device. Since the power sockets are usually disposed on the walls or in the corners of a house, the effective wireless transmission scope of the wireless devices is greatly affected thereby. Therefore, people used to add more wireless transmission devices in each corner or dispose an wireless transmission device in the center of the room by means of an extended line for acceptable signal transmission intensity. In this way, more money has to be spent and the “wireless” advantage for the wireless communication technique is lost.

In order to overcome the disadvantages existed in the prior art, a novel network equipment applied in the power line carrier communication system is provided. Through the present invention, more effective network communication quality is achieved.

### SUMMARY OF THE INVENTION

In accordance with one aspect of the present invention, a network equipment for a communication between a network and a plurality of computers is provided. The network equipment improves the respective structures of the conventional network adapter and wireless transmission device, and integrates them perfectly for enhancing efficacy and convenience of the wireless network transmission.

In accordance with another aspect of the present invention, a network equipment applied in the power line carrier communication system is provided, wherein the plug and the network port are disposed at one side of a network adapter so that the plug can be suitably received without juts. Moreover, the connector of a wireless network transmission device is designed in the form of a lamp base connect so that it can be plugged into a bulb socket on a ceiling.

In accordance with a further aspect of the present invention, a network equipment for a communication between a network and a plurality of computers is provided. The network equipment includes a network adapter for transmitting a network signal from a network via a conducting line and a wireless transmitting device for wirelessly transmitting the network signal to the plurality of computers via the conducting line, wherein the network adapter includes an adapter body, a receptacle portion disposed on the adapter body, and a plug to be inserted into a socket to transfer the network signal to the conducting line. The wireless transmitting device includes a device body and a lamp base connector connected with the device body, detachably and electrically connected with a bulb socket and wirelessly transmitting the network signal to the plurality of computers via the conducting line.

Preferably, the network equipment is applied in a power line carrier communication system, wherein the conducting line is a power line.

Preferably, the plug comprises a power supply line connected with the network adapter, and the power supply line transmits a power to the network adapter.

Preferably, the receptacle portion further comprises a first space for containing the plug.

Preferably, the receptacle portion further has a second space to contain the power supply line.

Preferably, the power line transmits a power to the network adapter and the wireless transmitting device.

Preferably, the network is one selected from a group consisting of an Internet, a local area network (LAN), a wide area network (WAN) and a virtual private network (VPN).

Preferably, the adapter body comprises a containing portion having a containing space for containing the lamp base connector of the wireless transmitting device.

Preferably, the adapter body further comprises a first fixture device for fixing the adapter body onto a plane while the network adapter settled alone.

Preferably, the wireless transmitting device further comprises a second fixture device for fixing the lamp base connector with the containing portion.

Preferably, the first and second fixture devices are bulges and grooves coupling with each other.

Preferably, the bulb socket is located on one selected from a group consisting of a ceiling, a wall, and a light stand.

Preferably, the network signal is transmitted from one of a modulator-demodulator and Ethernet to the network adapter by a network cable.

Preferably, the receptacle portion further comprises a network port for supporting a network cable to transmit the network signal.

Preferably, the power line connected with the socket and the bulb socket is disposed as a single loop.

In accordance with a further aspect of the present invention, a network adapter for transmitting a network signal via a conducting line is provided. The network adapter includes an adapter body, a plug, and a receptacle portion disposed on the adapter body, wherein the receptacle portion further comprises a network port supporting a network cable to transmit the network signal, and a first space for containing the plug, wherein the plug is connected with the conducting line to transfer the network signal.

Preferably, the receptacle portion comprises at least one terminal socket for receiving a terminal of the plug.

Preferably, the plug comprises a power supply line connected with the adapter body.

Preferably, the receptacle portion further has a second space to contain the power supply line.

Preferably, the plug is connected with the conducting line by a socket.

Preferably, the adapter body has a containing portion having a containing space for containing a lamp base connector of a wireless transmitting device.

In accordance with a further aspect of the present invention, a wireless transmitting device for a communication between a network and a computer is provided. The wireless transmitting device comprises a device body and a lamp base connector wirelessly transmitting a network signal to the computer.

Preferably, the network signal is received from a conducting line.

Preferably, the conducting line is a power line.

Preferably, the lamp base connector is connected with the device body and electrically connected with a bulb socket.

Preferably, the lamp base connector is detachably connected with the bulb socket.

Preferably, the network signal is transmitted via a conducting line.

Preferably, the device body has an indicator light for showing a working status of the wireless transmitting device.

Preferably, the wireless transmitting device is one of a wireless router and an access point.

The above objects and advantages of the present invention will become more readily apparently to those ordinarily skilled in the art after reviewing the following detailed descriptions and accompanying drawings, in which:

### BRIEF DESCRIPTION OF THE DRAWINGS

FIG. 1 is a schematic diagram showing the framework of a power line carrier communication system cooperating with a wireless network system in the prior art;

FIG. 2(A) is a schematic diagram showing the structure of a conventional network adapter device;

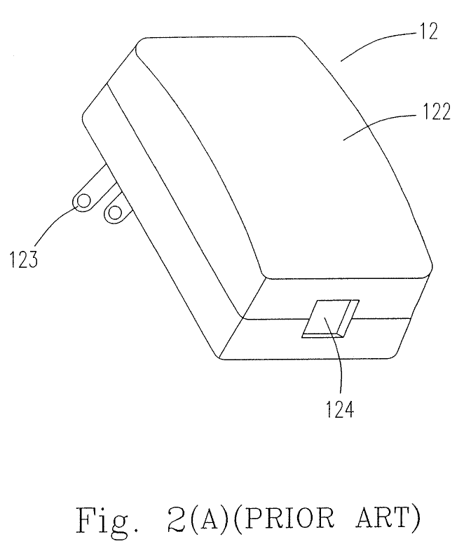

FIG. 2(B) is a schematic diagram showing the structure of a conventional wireless network transmission device;

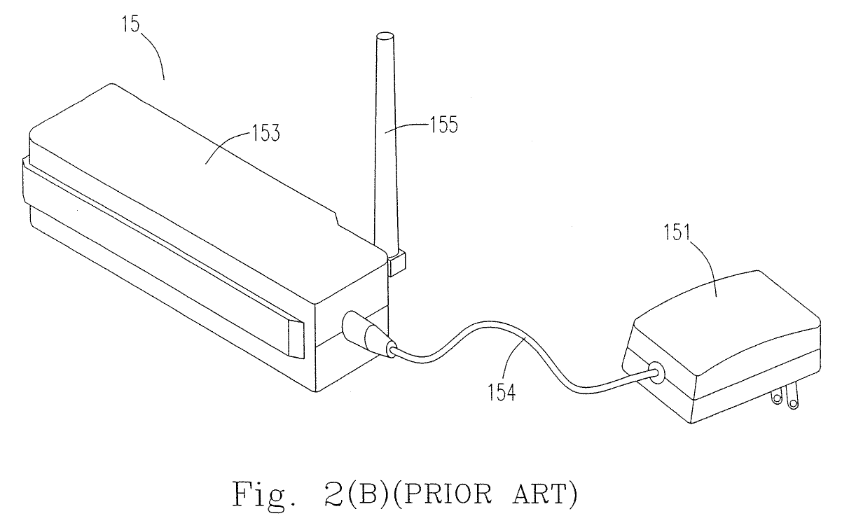

FIG. 3 is a schematic diagram showing the structure of a network equipment applied in the power line carrier communication system according to a preferred embodiment of the present invention;

FIG. 4 is a three-dimensional diagram showing the structure of the network adapter in the present invention, wherein the plug is drawn out of the adapter body;

FIG. 5 is a three-dimensional diagram showing the combination of the network adapter with the wireless transmitting device according to a preferred embodiment of the present invention; and

FIG. 6 is a schematic diagram showing the concrete practice for the network equipment in the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

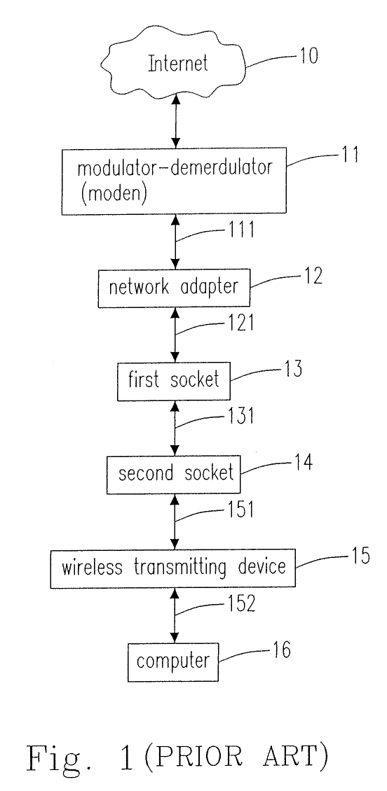

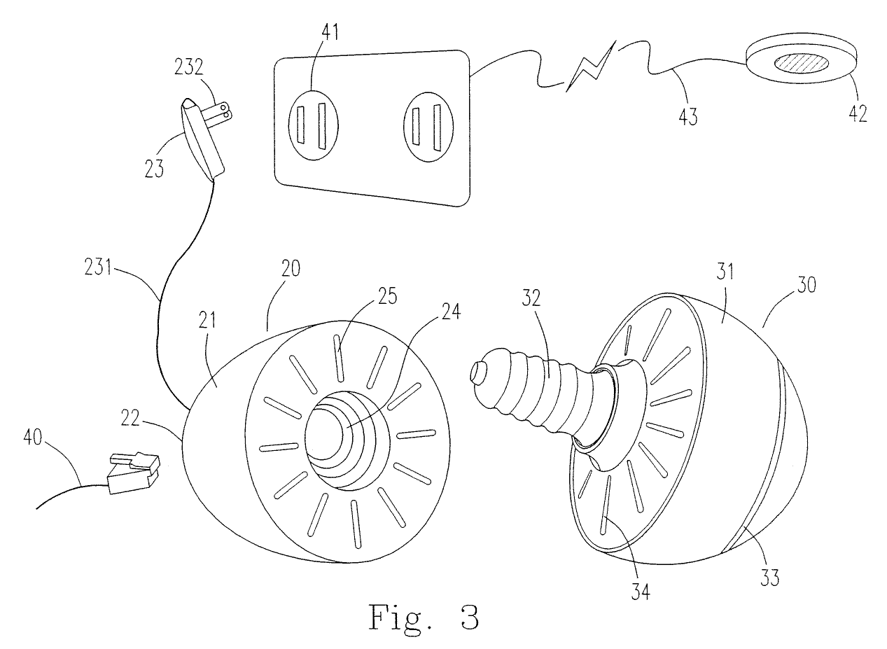

Please refer to FIG. 3, which is a schematic diagram showing the structure of a network equipment applied in the power line carrier communication system according to a preferred embodiment of the present invention. The network equipment mainly comprises a network adapter 20 and a wireless transmitting device 30. The network adapter 20 comprises an adapter body 21, a plug 23 connected with a power supply line 231, a receptacle portion 22 and a containing portion 24. The receptacle portion 22 further comprises a first space for containing the plug 23, a second space for containing the power supply line 231, and a network port for supporting a network cable 40 to transmit a network signal. The plug 23 is used to be inserted to a socket 41 to transfer the network signal to a power line electrically connected with the socket 41 (as shown in FIG. 1). The containing portion 24 is disposed at the other side of the adapter and has a containing space for containing a lamp base connector 32 of the wireless transmitting device 30.

The wireless transmitting device 30 includes a device body 31 and a lamp base connector 32 detachably and electrically connected with a bulb socket, so that the network signal is wirelessly transmitted to a plurality of computers via the power line connected with the bulb socket. The device body 31 further comprises a circular indicator light 33 for showing the working status of the wireless transmitting device 30.

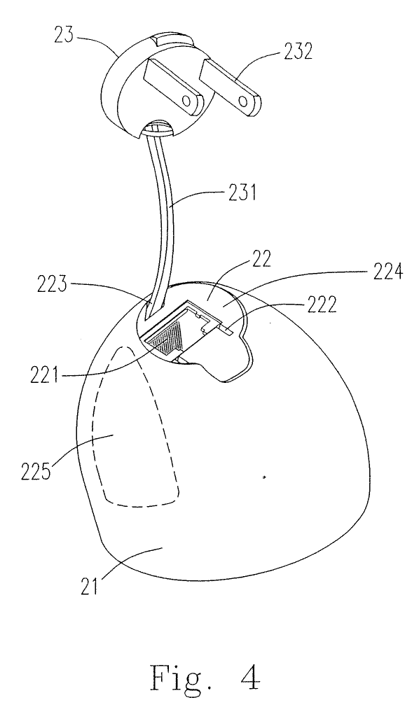

Please refer to FIG. 4, which is a three-dimensional diagram showing the structure of the network adapter in the present invention, wherein the plug 23 is drawn out of the adapter body. The receptacle portion 22 has a first space 224, a second space 225, a network port 221, at least one terminal socket 222, and a small opening 223, wherein the network cable 40 of FIG. 3 is inserted into the network port 221 for transmitting the network signal. The first space 224 is right suitable for containing the plug 23 therein when the network cable 40 of FIG. 3 is disconnected from the network port 221. The terminals 232 of the plug 23 are inserted into the terminal sockets 222, and the power supply line 231 is collected to be received in the second space 225 through the small opening 223.

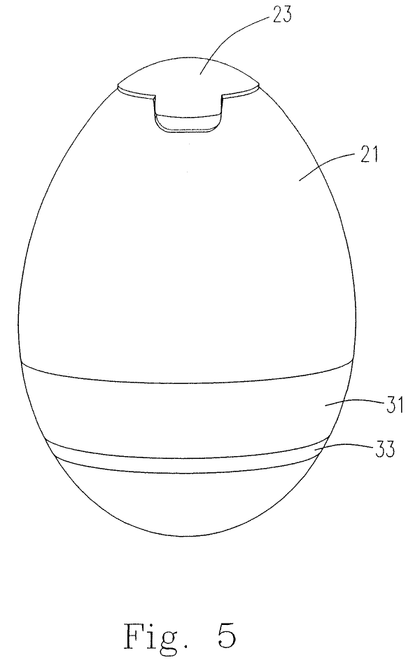

Please refer to FIG. 5 and FIG. 3 simultaneously, wherein FIG. 5 is a three-dimensional diagram showing the combination of the network adapter 20 with the wireless transmitting device 30 according to a preferred embodiment of the present invention. The plug 23 and the power supply line 231 of the network adapter can be perfectly hidden in the adapter body 21 owing to the arrangement described above. Moreover, the lamp base connector 32 of the wireless transmitting device 30 can be exactly received in the containing portion 24 of the network adapter 20. Consequently, the combination of the two device bodies turns into a slick and exquisite egg-shaped structure, which is convenient for carrying with.

Since the lamp base connector 32 is shaped spirally, the inner wall of the containing portion 24 can also be shaped spirally (as shown in FIG. 3), such that the wireless transmitting device 30 can be rotated into the containing portion 24 for firmly connection with the network adapter 20. However, the lamp base connector 32 is not limited to a spiral shape; it can be designed in various shapes, e.g. a wedge-shaped connector of a fluorescent tube, where the shape variation of the connector is still included within the spirit and scope of the present invention. Meanwhile, the form of the containing portion 24 may vary to match different connectors.

Furthermore, in order to strengthen the combination of the network adapter 20 with the wireless transmitting device 30, and prevent it from detachment by an external force, for example a collision, the adapter body 21 has at least a first fixture device 25 and the device body 31 has at least a second fixture device 34 corresponding thereto, which provides a better fixing effect when the lamp base connector 32 is connected with the containing portion 24. The first fixture device 25 can be a bulge or a groove, while the second fixture devices 34 correspondingly can be a groove or a bulge. Furthermore, the bulge-shaped first fixture device 25 will help fix the network adapter body 21 onto a plane when the network adapter 20 is used independently.

In addition, the receptacle portion 22 and the containing portion 24 are disposed at two sides of the network adapter body 21 respectively, wherein the receptacle portion 22 can be a fillister. Nevertheless, the receptacle portion 22 and the containing portion 24 may be disposed anywhere in the network adapter body 21 for any functional requirements or purposes in the modeling design, and is not limit to the disposal described above.

Furthermore, the power line 43 connected with the socket 41 and bulb socket 42 is a unitary circuit, wherein the bulb socket 42 can be disposed on a ceiling and the power line 43 transmits power to the network adapter 20 and the wireless transmitting device 30 separately. The network signal is transmitted from a modern or an Ethernet to the network adapter 20 by a network cable. The wireless transmitting device 30 can be one of a wireless router and an access point.

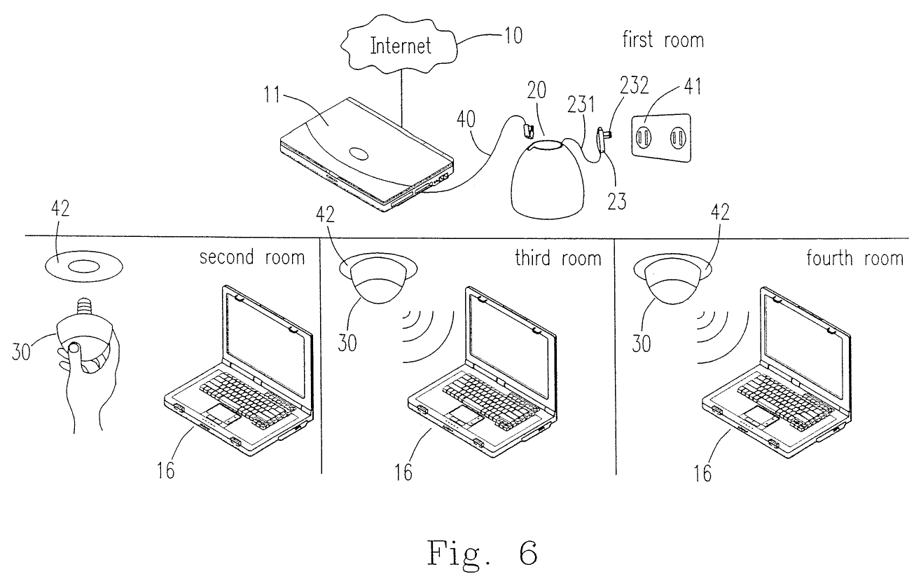

Please refer to FIG. 6, which is a schematic diagram showing the framework of the concrete practice for the network equipment in the present invention. The network signal of an internet 10 is transmitted into a house containing four rooms by means of a moden 11, which is disposed in the first room.

Using the conventional network layout, the computers 16 in the other rooms are hardly to receive the network signal via a wireless router or an access point placed in the first room because of the signal block, except extending the network cables to each room. In the present invention, we just need to separate the network equipment into two independent devices, the network adapter 20 and the wireless transmitting device 30, and pull out the power supply line 231 and the plug 23, and insert the plug 23 into the socket 41, and insert the network cable 40 connected with the modem 11 into the network port 221, and respectively rotate three wireless transmitting devices 30 into the existing bulb sockets 42 on the ceilings of the second room, third room and fourth room, and then the network signal is transmitted to the computers 16 in each room without burdensome and redundant cables, thereby achieving the effective wireless network transmission.

Since the wireless transmitting device 30 can be inserted into a bulb sockets 42 on the ceiling or any other bulb socket of a lamp device indoors and outdoors just like an ordinary bulb, for example a desktop light, a streetlamp or a socket in the utility pole, the effective wireless transmission scope can be effectively extended because of the higher position of the access point and less block.

In conclusion, the present invention indeed provides a network equipment applied in a power line carrier communication system, which overcomes the structural defects of the conventional wireless transmitting device, and perfectly combines the wireless transmitting device with the network adapter to be an integrated product which is easily received and stored up. Since the connector of the wireless transmitting device connector is made as the connector for a lamp base, it can be inserted into any bulb and lamp socket, especially the socket on the ceiling, without changing the existing power circuit arrangement. Besides, the practice of the network equipment is very simple and convenient, and the cost thereof is quite low.

In Sum, the network equipment for the power line carrier communication system in the present invention has the advantages of easy establishment, low cost, higher convenience and wide application. Accordingly, the present invention can effectively solve the problems and drawbacks in the prior art, and thus it fits the demand of the industry and is industrially valuable.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A network equipment for a communication between a network and a computer, comprising:
a network adapter transmitting a network signal from the network via a conducting line, and comprising:
an adapter body;
a receptacle portion disposed on the adapter body; and
a plug to be inserted into a socket to transfer the network signal to the conducting line; and
a wireless transmitting device comprising
a device body; and
a lamp base connector connected with the device body, detachably and electrically connected with a bulb socket and wirelessly transmitting the network signal to the computer via the conducting line.

2. The network equipment according to claim 1 being applied in a power line carrier communication system, wherein the conducting line is a power line.

3. The network equipment according to claim 2, wherein the plug comprises a power supply line connected with the network adapter, and the power supply line transmits a power to the network adapter.

4. The network equipment according to claim 3, wherein the receptacle portion further comprises a first space for containing the plug.

5. The network equipment according to claim 4, wherein the receptacle portion further has a second space to contain the power supply line.

6. The network equipment according to claim 1, wherein the power line transmits a power to the network adapter and the wireless transmitting device.

7. The network equipment according to claim 1, wherein the network is one selected from a group consisting of an Internet, a local area network (LAN), a wide area network (WAN) and a virtual private network (VPN), and the network signal is transmitted from one of a modulator-demodulator and Ethernet to the network adapter by a network cable.

8. The network equipment according to claim 1, wherein the adapter body comprises a containing portion having a containing space for containing the lamp base connector of the wireless transmitting device.

9. The network equipment according to claim 8, wherein the adapter body further comprises a first fixture device for fixing the adapter body onto a plane while the network adapter settled alone.

10. The network equipment according to claim 9, wherein the wireless transmitting device further comprises a second fixture device for fixing the lamp base connector with the containing portion.

11. The network equipment according to claim 10, wherein the first and second fixture devices are bulges and grooves coupling with each other.

12. The network equipment according to claim 1, wherein the bulb socket is located on one selected from a group consisting of a ceiling, a wall, and a light stand.

13. The network equipment according to claim 1, wherein the receptacle portion further comprises a network port for supporting a network cable to transmit the network signal.

14. The network equipment according to claim 2, wherein the power line connected with the socket and the bulb socket is disposed as a single loop.

15. A network adapter for transmitting a network signal via a conducting line, comprising:
an adapter body;
a plug to be connected with the conducting line to transfer the network signal; and
a receptacle portion disposed on the adapter body, and comprising
a network port supporting a network cable to transmit the network signal; and
a first space for containing the plug.

16. The network adapter according to claim 15, wherein the receptacle portion comprises at least one terminal socket for receiving a terminal of the plug.

17. The network adapter according to claim 15, wherein the plug comprises a power supply line connected with the adapter body, and connects with the conducting line by a socket.

18. The network adapter according to claim 15, wherein the plug is connected with the conducting line by a socket.

19. The network adapter according to claim 15, wherein the adapter body has a containing portion having a containing space for containing a lamp base connector of a wireless transmitting device.

20. A wireless transmitting device for a communication between a network and a computer, comprising:
a device body; and
a lamp base connector connected with the device body and wirelessly transmitting a network signal to the computer via a conducting line.

21. The wireless transmitting device according to claim 20, wherein the lamp base connector is electrically and detachably connected with a bulb socket.

22. The wireless transmitting device according to claim 20, wherein the device body has an indicator light for showing a working status of the wireless transmitting device.

23. The wireless transmitting device according to claim 20 being one of a wireless router and an access point.
